(19) United States
(12) Patent Application Publication
(10) Pub. No.: US 2014/0361886 A1
(43) Pub. Date: Dec. 11, 2014

(54) Gun Shot Detector

(71) Applicant: Vince Cowdry, Lake St. Louis, MO (US)

(72) Inventor: Vince Cowdry, Lake St. Louis, MO (US)

(21) Appl. No.: 14/300,771

(22) Filed: Jun. 10, 2014

Related U.S. Application Data
(60) Provisional application No. 61/833,603, filed on Jun. 11, 2013.

(51) Int. Cl. G08B 21/02; G08B 19/00

(52) U.S. Cl. CPC G08B 21/02; G08B 19/00
USPC 340/522

(57) ABSTRACT

A gunshot detection system provides an audio and visual surveillance system, embodied within a Gunshot Detector (GSD) attached to a building's walls and ceilings and a Firearm Event Detector (FED) worn on a person's outer clothing. In both embodiments, the system of the invention detects the physical signatures of a firearm discharge, specifically sound from a muzzle blast and light from a muzzle flash. The system would be linked to a software program and/or electronic transducer(s) and/or microprocessor(s) and/or electronic Logic Circuitry (using algorithms, logic gates) that would apply one or more identification algorithms to distinguish firearm discharge from other signals. Either embodiment may be linked to an emergency notification system or to a “Guardian Barrier System” (GBS) wherein a facility or premises, for example a school, is equipped with electromagnetically releasable and electromagnetically lockable doors such that facility or premises may be automatically locked down.

### CROSS-REFERENCE TO RELATED APPLICATIONS

This application claims priority to U.S. Provisional Application No. 61/833,603, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### BACKGROUND OF THE INVENTION

The invention relates generally to security devices and in particular to a gunshot detection system. For residential and commercial applications, there is demand for devices that will detect possibly illegal or life-threatening activity, such as glass breakage detectors, smoke detectors, and carbon monoxide detectors. Gun violence is a related concern that presently lacks an automated detection device. A system that detects the physical signatures of a firearm discharge, specifically muzzle blast sound and muzzle flash light and heat, would help to detect possibly illegal or life threatening activity in a secure setting, for example schools, universities, offices, banks, restaurants, retail businesses, courthouses, and government buildings. Similarly, a portable system to be carried by police, military, security, or other at-risk individuals would bring gunshot detection wherever there is a need to quickly identify and locate incidents of gun violence.

An audio and visual surveillance system would be linked to a software and/or electronic transducer(s) and/or microprocessor(s) and/or electronic Logic Circuitry (using algorithms, logic gates) that would apply one or more identification algorithms to distinguish firearm discharge from other signals. The software program and/or electronic transducer(s) and/or microprocessor(s) and/or electronic Logic Circuitry (using algorithms, logic gates) and/or electronic transducer(s) and/or microprocessor(s) and/or electronic Logic Circuitry (using algorithms, logic gates), upon identifying a firearm discharge, would respond by automatically triggering an alarm, which may include an automated building alarm, automatic notification of emergency services, or automatic notification of a private security provider.

### SUMMARY OF THE INVENTION

Accordingly, the invention is directed to a gunshot detection system. An audio and visual surveillance system, embodied within a Gunshot Detector (GSD) attached to a building's walls and ceilings and a Firearm Event Detector (FED) worn on a person's outer clothing. In both embodiments, the system of the invention detects the physical signatures of a firearm discharge, specifically sound from a muzzle blast and light from a muzzle flash. The system would be linked to a software program and/or electronic transducer(s) and/or microprocessor(s) and/or electronic Logic Circuitry (using algorithms, logic gates) that would apply one or more identification algorithms to distinguish firearm discharge from other signals. Either embodiment may be linked to an emergency notification system or to a “Guardian Barrier System” (GBS) wherein a facility or premises, for example a school, is equipped with electromagnetically releasable and electromagnetically lockable doors such that facility or premises may be automatically locked down.

In the case of the Gunshot Detector, the software program and/or electronic transducer(s) and/or microprocessor(s) and/or electronic Logic Circuitry (using algorithms, logic gates), upon identifying a firearm discharge, would respond by automatically triggering an alarm, which may include an automated building alarm, automatic notification of emergency services, or automatic notification of a private security provider, as well as the activation of a Guardian Barrier System.

By contrast, the Firearm Event Detector is intended to be worn on a person as a safety device, which would provide notification of the proper authorities, should the wearer be attacked by a firearm. Through the Firearm Event Detector, the software program and/or electronic transducer(s) and/or microprocessor(s) and/or electronic Logic Circuitry (using algorithms, logic gates), upon identifying a firearm discharge, would respond by automatically triggering an alarm, which may include automatic notification of the user's organization (e.g. police department), general emergency services, or a private security provider, as well as the activation of a Guardian Barrier System.

In the preferred embodiment, the electronic sensor technologies used will be the detection of:
(a) The various properties and characteristics of light generated from the muzzle flash from a firearm.
(b) The various properties and characteristics of sound generated from a muzzle blast from a firearm.
(c) The various properties and characteristics detected would be combined through software and/or electronic transducer(s) and/or microprocessor(s) and/or electronic Logic Circuitry (using algorithms, logic gates) to actuate an alarm condition to appropriate authority.

In the preferred embodiment, the Gunshot Detector (GSD) will have the following properties:
(a) A peripheral detection device resembling a smoke detector interfaced to existing alarm systems, dedicated alarm systems or to telemetry devices, which will send alarm in a firearm discharge condition to the proper authorities.
(b) For portability, a device(s) could be interfaced to a portable telemetry device.
(c) Attaches to the ceilings and walls of hallways and rooms in buildings.
(d) Coverage/detection range for a particular embodiment may be determined at the time of manufacture.

In the preferred embodiment, the Firearm Event Detector (FED) will have the following properties:
(a) A body worn or mobile mounted detection device resembling a small cell phone or possibly smaller.
(b) Interfaced via Bluetooth to a Smart Phone or other telemetry device, which will send alarm in a firearm discharge condition to the proper authorities.
(c) Unit to have built in Bluetooth Pairing capabilities. The unit's capabilities may include audible and/or visible properties for rescuers to find in the case the wearer goes inactive after the event. It should have status light(s) for connectivity and power. Through the phone app, the GPS location could be used to locate the event.
(d) Each unit to have unique encrypted coding to ensure proprietary exclusivity for licensed companies to maintain, lease or sell this technology. It should be able to communicate with an encrypted Android/I-Phone application or an encrypted telemetry device.
(e) While designed for frontal attack and ambush, consider having a modular connection for the rear.
(f) Coverage/detection range for this device to be determined. Desired range would be in the vicinity of 50 feet.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate three embodiments of the invention and, together with the description, serve to explain the principles of the invention.

FIGS. 1 and 2 illustrate a conceptual drawing of the body-worn Firearm Event Detector in a single exemplary embodiment. The Firearm Event Detector should accordingly not be taken to necessarily have the appearance as shown in the figures.

FIG. 1 shows a front view of the Firearm Event Detector second exemplary embodiment, displaying the firearm event detector 10, the wire 12, the control unit 13, light sensor 14, and the acoustic microphone 15.

FIG. 2 shows a side view of the Firearm Event Detector second exemplary embodiment, displaying the firearm event detector 10, two clips 11, the wire 12, the control unit 13, and two on/off switches 16.

FIGS. 3 and 4 illustrate a conceptual drawing of the body-worn Firearm Event Detector in an alternative configuration. The Firearm Event Detector should accordingly not be taken to necessarily have the appearance as shown in the figures.

FIG. 3 shows a front view of the alternative configuration of the second exemplary embodiment, displaying the firearm event detector 13, the acoustic microphone 15, and the light sensor 14.

FIG. 4 shows a side view of the alternative configuration of the second exemplary embodiment, displaying the firearm event detector 10, the clip 11, the control unit 13, and the on/off switch 16.

FIG. 5 illustrates a conceptual drawing of the wall and ceiling mounted Gunshot Detector in a single exemplary embodiment. The Gunshot Detector should accordingly not be taken to necessarily have the appearance as shown in the figure.

FIG. 5 shows a side view of the Gunshot Detector first exemplary embodiment, displaying the firearm event detector 10, the control unit 13, and the housing 17.

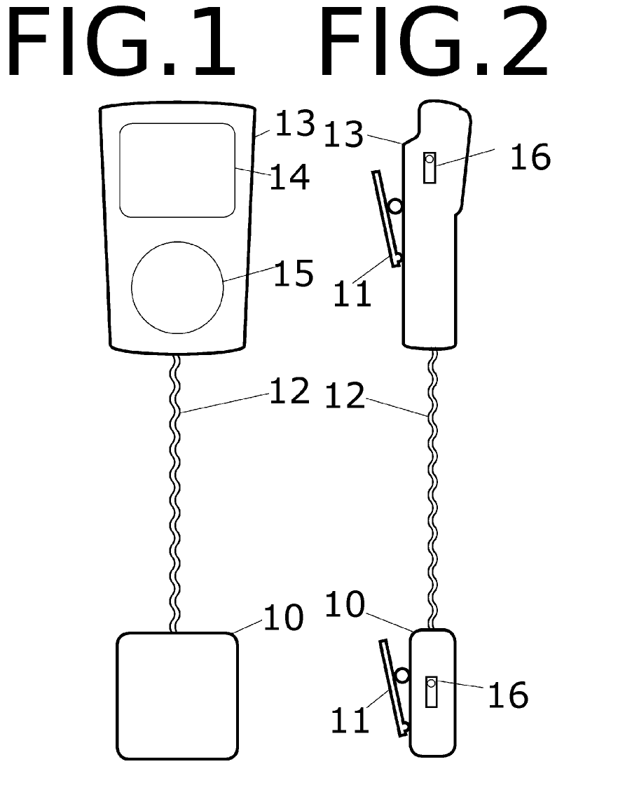

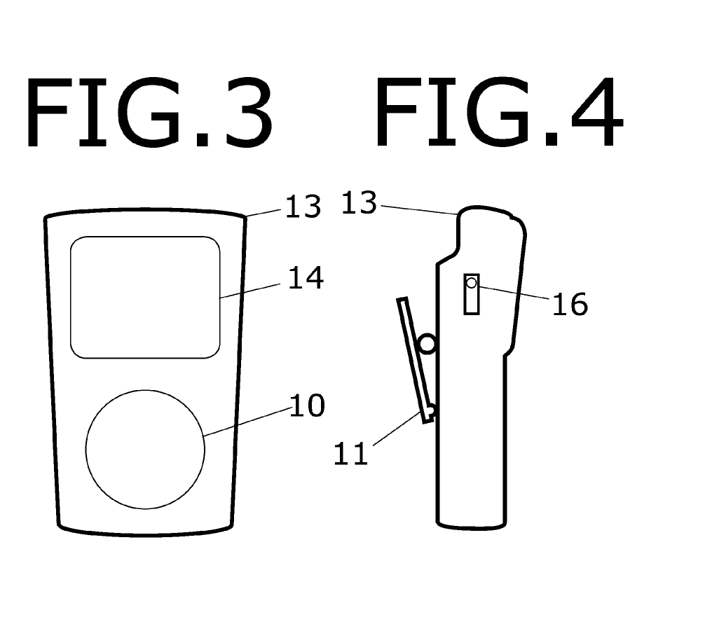

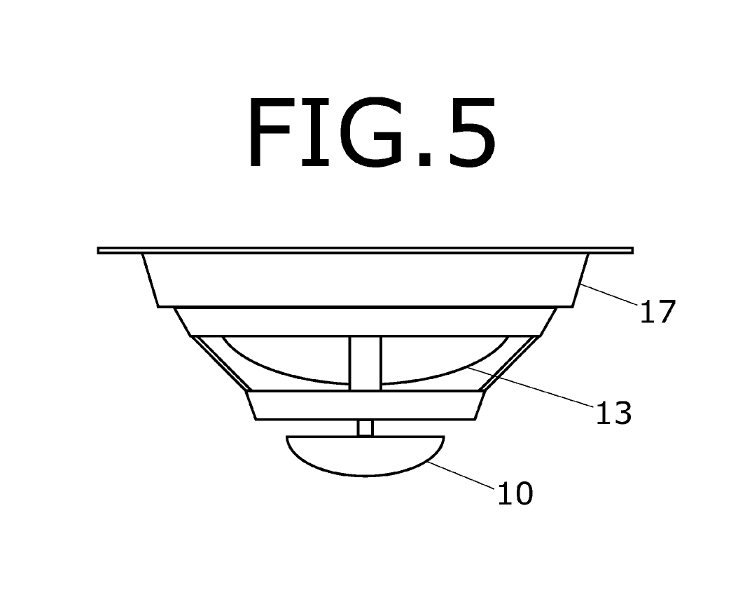

### DETAILED DESCRIPTION OF THE INVENTION

Referring now to the invention in more detail, the invention is directed to a gunshot detection system. An audio and visual surveillance system may be embodied within a Gunshot Detector (GSD) device attached to a building's walls and ceilings and a Firearm Event Detector (FED) device may be worn on a person's outer clothing. In both embodiments, the system of the invention detects the physical signatures of a firearm discharge, specifically sound from a muzzle blast and light from a muzzle flash. Either sound sensing (including sounds at inaudible frequencies), or light sensing (including light at invisible wavelengths), or other sensing may be employed; such sensors may generically be understood as sensing means for sensing the physical signatures of a firearm discharge. All sensing means employed would preferably be effective at a range of at least sixty feet from the position of the sensor (larger than the expected danger area as the majority of gun violence in general and gun violence on police officers is known to occur at close range). However, the actual effective range of any individual embodiment of the system should be adjustably limited so as to avoid double coverage from the same firearm discharge. The sensing system would be linked to a software program and/or electronic transducer(s) and/or microprocessor(s) and/or electronic Logic Circuitry (using algorithms, logic gates) that would apply one or more identification algorithms to distinguish firearm discharge from other signals. Whether such algorithms are embodied in a software program for execution on a microprocessor, directly as digital logic circuitry, in an analog form, or otherwise, such algorithmic implementation may be generically understood as a computing means for computing an algorithm. Generically, the sensing means for sensing the physical signatures of a firearm discharge and the computing means for computing an algorithm are understood to be in electronic communication or otherwise in communication such that the sensing means for sensing the physical signatures of a firearm discharge provide input to the detection algorithms. Regardless of the particular computing means employed, the computing means preferably has the ability to be upgraded via firmware, EEPROM, or other aftermarket reprogramming techniques.

The system of the invention provides one or more output notifications in response to a detection of firearm discharge. Outputs may include alarms directed to building occupants, emergency services, law enforcement, private security, and the content may simply be an alert, or may include telemetry data on the approximated position of the Either embodiment may be linked to an emergency notification system or to a “Guardian Barrier System” (GBS) wherein a facility or premises, for example a school (generically, a “building”), is equipped with electromagnetically releasable and electromagnetically lockable doors such that facility or premises may be automatically locked down. In a GBS, facility doors are preferably selectively held open or held shut by electromagnetic locking devices. In a lockdown, the GBS would remotely release all doors held open and engage the doors to shut; this state may be generically understood as a “lockdown configuration”. The system may distinguish between firearms occurring in a room as opposed to a corridor, and may leave the door of a room with an event open to facilitate escape from that room. Additionally, appropriate bypass methods, for example keypad access, may be provided for use by supervisory persons and law enforcement. Doors would not be generally openable again until the emergency condition is cleared from the system. Doors in the facility employing a GBS would preferably be durable and resistant to physical attack for a sufficient period for response to arrive. Generically, all outputs may be understood as response means for responding to a firearm discharge. All outputs may be generically understood as in electronic communication or otherwise in communication with the computing means for computing an algorithm.

In the first exemplary embodiment, a fixed-location Gunshot Detector (GSD) is mounted on the wall or ceiling of a building or structure (generically, “in a fixed position on a building”) and is integrated with the building's burglar/fire alarm system. An alarm system panel may also be dedicated to the use of a Gunshot Detector. Each GSD would be assigned its own zone number in the panel, presumably for a room or section of hallway. A troubled zone could then be pinpointed so law enforcement or other emergency responders would know exactly where to respond. A Gunshot Detector looks similar to a smoke detector or carbon monoxide detector and attaches to ceilings and walls, but is dedicated to the detection of a muzzle flash and muzzle blast from a firearm. The algorithm to be computed by the computing means would, upon identifying a firearm discharge, respond by response means, which may include an automated building alarm, automatic notification of emergency services, or automatic notification of a private security provider.

In the second exemplary embodiment, a Firearm Event Detector (FED) is worn on a user's body and is intended to make notification if the wearer is fired upon by another with a firearm. Similar systems and methods to the first exemplary embodiment are employed to achieve accurate detection of firearm discharge. The device would be able to send an alarm to the appropriate authorities, including the user's own law enforcement or other parent organization directly, thus initiating a “call for backup”. An audio and visual surveillance system, embodied within a firearm event detector (FED) 13 worn on a person's outer clothing, detects the physical signatures of a firearm discharge, specifically sounds and muzzle flash. The FED 13 would be linked to the algorithm to be computed by the computing means. The algorithm would, upon identifying a firearm discharge, present a response means.

Components of the system include an FED 13; a control unit 13; and a command unit. Electronic components in the FED 13 include an infrared detector and an acoustic detector. Electronic components in the control unit 13 include a microprocessor, a memory device, software necessary to operate the system, a universal serial bus (USB) port, and an on/off switch 16, and may also include a light sensor 14, and an acoustic microphone 15. Electronic components in the command unit include a microprocessor, a memory device, software necessary to operate the system, a USB cable for transfer of command parameters to the control unit 13, a visual display, a keypad or other data input device, an on/off switch 16, and a quickly changeable rechargeable battery or other power source. A single command unit may be used to configure and calibrate multiple control units 13. Alternate embodiments, featuring the transfer of command parameters from the command unit to control units 13 using wireless technology, are also contemplated. Example command parameters include microphone gain adjustment control, filtration level, selection of decision criteria, and selection of output criteria.

Both the FED 13 and control unit 13 may be affixed to the user's clothing using clips 11. Both the FED 13 and control unit 13 feature on/off switches 16. To use the second exemplary embodiment, the user connects the USB cable of the command unit to the USB port of the control unit 13, switches all on/off switches 16 on all components to the “on” position, uses the keypad or other data entry device to calibrate the control unit by transferring command parameters from the command unit to the control unit 13, disconnects the USB cable from the USB port, and affixes the control unit 13 and the FED 13 to the user's clothing, using the clips 11 that have been provided. The command parameters, software, and other onboard data are preferably encrypted, such that the device may not be tampered-with or readily reprogrammed.

The GSD 10 and FED 13, and the software or other control system supporting it, would be designed to detect and recognize three signature elements of a firearm discharge: muzzle flash, muzzle blast, and duration of noise. Either sound detection, light detection, both, or multiple complementary detectors of either or both may be present in any given system. Detectors may be omnidirectional or unidirectional, and may be configured to provide heading information if, for example, if the heading of the unidirectional detector is known or if multiple omnidirectional detectors take complementary readings. In particular, omnidirectional sensitivity, which is understood by the inventor to be more readily available in sound detectors than light detectors, is preferred at a minimum over the ability to determine heading, due to the danger that a firearm discharge may come from any direction, especially in the body-worn FED embodiment. Thus, where only a single sensor is provided, an omnidirectional acoustic microphone is preferred. Muzzle flash can be detected through infrared or visible light signatures at a great distance. Muzzle flash may be characterized both for light observed directly from the firearm discharge and reflected light having reached the system of the invention indirectly. The infrared sensor in the FED 13 may be an infrared sensitive complementary metal-oxide sensor (CMOS) camera, a mid-wave infrared photodetector, a mid-wave infrared (IR) passing filter in conjunction with an IR detector, a near IR passing filter in conjunction with an IR detector, a near IR photodetector, or a photoelectric sensor. Light detection wavelengths will include one or more of the following: mid-wave infrared, short wave infrared, near infrared, long wave infrared, and visible light wave.

Muzzle blast is the level of noise. A typical muzzle blast generates an impulse sound wave with a sound pressure level (SPL) within a pre-determined range of decibels (dB). The acoustic sensor will be configured to match the SPL range of a firearm discharge. The acoustic sensor may be configured for the blast duration (measurement in milliseconds), and is capable of measuring decibel (dB) noise level, sound pressure level, peak pressure level, hertz frequency, and overpressure wave. A band-pass filter, optional in two, three, or more stages may be applied to isolate frequencies characteristic of muzzle blast. One or more of the various properties and characteristics detected would be in the algorithm to be computed by the computing means.

To possibly protect the GSD and FED from false alarms, the muzzle flash and muzzle blast must occur in a given millisecond time frame. If the event occurs within certain predetermined distances, the specified time measurement would be a verifying factor sent to the algorithm, and if other requirements such as flash and blast are met, then the alarm is sent. So, if flash and blast from a lightning bolt outdoors occurs outside the predetermined distance, then there will be no alarm. For an FED unit affixed to the clothing of a person, the default setting must be at least 50 feet, preferably 60 feet. In that setting, the firearm event must trigger from 0 feet to the distance threshold setting.

In this manner, the acoustic and infrared sensors are configured to filter out everything but the specified triggering ranges of audio and infrared events. These three elements would have to be present to activate the alarm notification. By using the USB cable to connect the command unit to the control unit, and using the keypad or other data entry device to specify command parameters for the control unit, the user may establish whether one, two, or all three elements must be present to activate the alarm notification, and the sensitivity levels corresponding to each element, based on the amount of space that must be covered. The control features in the control unit 13 represents three separate electronic switches, each designed to trip under their designed parameters in the same time frame, configured to close a circuit that would activate a panic alarm, which would prevent false alarms. All embodiments feature variable sensitivity switches to help maximize the efficiency of the system.

The second exemplary embodiment (Firearm Event Detector) is preferably interfaced via Bluetooth™ to a smartphone or other telemetry device, which will send an alarm in a firearm discharge situation to the proper authorities. The system has built in Bluetooth Pairing capabilities, audible and/or visible properties and/or global positioning satellite (GPS) location for rescuers to find in the case the wearer goes inactive after the firearm discharge. The FED device may pair with a mobile data device, for example a smartphone or tablet, or with other devices, for example a police cruiser computer system. Alarm transmission as well as GPS and/or cellular telemetry may be achieved using the mobile device's onboard capabilities, for example via customized software ‘App’. The system also features one or more status lights for connectivity and power. Each system has unique encrypted coding to ensure proprietary exclusivity for licensed companies to maintain, lease or sell this technology. Each system is able to communicate with an encrypted Android® or IPhone® application or an encrypted telemetry device.

Incorporating the concepts of the invention, the software process to be computed by the computing means may be understood to comprise continuously monitoring the sensing means, applying a decision algorithm to determine detection or non-detection of a firearm discharge, and automatically triggering a response means. The specific features of the algorithm may include using any or all of the following techniques alone or in combination: (i) filtering sound input by a predetermined range of average or peak sound pressure levels; (ii) filtering sound input by sound duration; (iii) filtering sound input by band pass filtration according to predetermined frequency ranges; (iv) comparing detected sound to a local or remote database of recorded or abstracted gunshot muzzle blasts, optionally by direct logical comparison or by comparison to a neural network pre-trained on muzzle blast differentiation (such as neural network comparisons being well-known in the prior art); (v) filtering light input by a predetermined range of average or peak brightness levels; (vi) filtering light input by illumination duration; (vii) filtering light input by band pass filtration according to predetermined wavelength ranges; (viii) comparing detected light to a local or remote database of recorded or abstracted gunshot muzzle flashes, optionally by direct logical comparison or by comparison to a neural network pre-trained on muzzle flash differentiation (such as neural network comparisons being well-known in the prior art); (ix) calculating distance between the system of the invention and the firearm discharge by the difference in time between the muzzle blast and muzzle flash, as related by the speed of light in air, and using the calculated distance as a limiting condition on the detection or non-detection of a firearm discharge; (x) obtaining, from onboard or remote GPS, mobile telemetry, or predetermined positioning data, the system's position; and (xi) combining device position and firearm event distance, optionally enhanced by firearm discharge heading or locale map data to localize the firearm discharge. The software process would further be capable of engaging any of the following response means: (i) causing a local building alarm to activate in the locale of the system of the invention; (ii) notifying general emergency/911 services in the locale of the system of the invention; (iv) notifying a private or third party security provider associated with the locale of the system invention; (v) engaging a Guardian Barrier System or other local lockdown in the locale of the invention; (vi) including in the alarm notification, regardless of destination, telemetry information of the system of the invention that has been activated; (vii) including in the alarm notification, regardless of destination, telemetry information of the location of the firearm discharge; (ix) in the case of a body-worn Firearm Event Detector, notifying the user's immediate team members or parent organization of the user's experience of a firearm discharge; (x) accessing a remote mobile device such as a mobile phone or police cruiser computer system to transmit a message using the remote device's communication capabilities (e.g. SMS messaging, voice call, email, etc., generically an “electronic communication”); and (xi) sending broadcast emergency notifications, for example via SMS message or other electronic communication, to a large number of subscribed users.

Additional features and functions may be added to the device and software process. Specifically, the FED may be equipped with a recessed “duress” button through which the user may signal that they are not free to act, an impact sensor capable of detecting a vehicle accident, a biometric sensor to determine the user's vital status, a beacon flash or sound by which the system and the user may be located, and remote listening capability. These functions would be interlinked with the firearm discharge detection algorithm to enhance decision-making and telemetry or may be viewed as standalone features.

The FED 13, the clips 11, the control unit 13, the acoustic microphone 15, the on/off switches 16, the housing 17, the memory devices, and the microprocessors would preferably be manufactured from durable, rigid materials such as steel, aluminum, high-impact plastic, and copper alloys. The device casing would preferably be water-resistant. The wire 12 would preferably be manufactured from copper alloy sheathed in plastic. The light sensor 14 would preferably be manufactured using a pass through filter conducive with the best muzzle sensing method.

Components and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A system and method for automatically detecting the discharge of a firearm comprising:
(a) at least one sensing means for sensing the physical signature of a firearm discharge;
(b) a computing means for computing a software process;
(c) said at least one sensing means for sensing the physical signature of a firearm discharge providing input to said computing means for computing a software process;
(d) at least one response means for responding to a firearm discharge;
(e) said at least one response means for responding to a firearm discharge being in electronic communication with said computing means for computing a software process;
(f) a software process;
(g) said computing means for computing a software process being configured to execute said software process;
(h) a decision algorithm;
(i) said software process comprising continuously monitoring said at least one sensing means for sensing the physical signature of a firearm discharge, applying said decision algorithm to determine detection or non-detection of a firearm discharge, and automatically triggering said at least one response means for responding to a firearm discharge;
(j) said algorithm comprising any combination of the group of decision techniques of (i) filtering sound input by a predetermined range of sound pressure levels; (ii) filtering sound input by sound duration; (iii) filtering sound input by band pass filtration according to predetermined frequency ranges; (iv) comparing detected sound to a database of gunshot muzzle blasts; (v) filtering light input by a predetermined range of brightness levels; (vi) filtering light input by illumination duration; (vii) filtering light input by band pass filtration according to predetermined wavelength ranges; (viii) comparing detected light to a database of gunshot muzzle flashes; or (ix) calculating distance between said system and a firearm discharge by the difference in time between the muzzle blast and muzzle flash and using the resulting distance as a limiting condition.

2. The system and method for automatically detecting the discharge of a firearm of claim 1 wherein said system is housed in a body-worn device.

3. The system and method for automatically detecting the discharge of a firearm of claim 1 wherein said system is housed in device mounted in a fixed position on a building.

4. The system and method for automatically detecting the discharge of a firearm of claim 1 wherein said at least one sensing means for sensing the physical signature of a firearm discharge comprises both an acoustic microphone and a light sensor.

5. The system and method for automatically detecting the discharge of a firearm of claim 1 wherein said at least one sensing means for sensing the physical signature of a firearm discharge comprises only an acoustic microphone.

6. The system and method for automatically detecting the discharge of a firearm of claim 1 wherein said software process further comprises determining the position of said system and reporting the position of said system to said at least one response means for responding to a firearm discharge.

7. The system and method for automatically detecting the discharge of a firearm of claim 6 further comprising localizing the position of a firearm discharge relative to the position of said system by calculating the distance between said system and said firearm discharge by the difference in time between the muzzle blast and muzzle flash of said firearm discharge, and combining the position of said system and the position of said firearm discharge to determine the location of said firearm discharge, and reporting the position of said firearm discharge to said at least one response means for responding to a firearm discharge.

8. The system and method for automatically detecting the discharge of a firearm of claim 7 further comprising calculating the heading of said firearm discharge to further refine the determined position of said firearm discharge, and reporting the position of said firearm discharge to said at least one response means for responding to a firearm discharge.

9. The system and method for automatically detecting the discharge of a firearm of claim 2 wherein said at least one response means for responding to a firearm discharge comprises directly notifying a parent organization of a human user of said system.

10. The system and method for automatically detecting the discharge of a firearm of claim 2 wherein said system further comprises a plurality of command parameters, said command parameters being securely configurable by a command unit.

11. The system and method for automatically detecting the discharge of a firearm of claim 3 wherein said building is equipped with a system of electromagnetically releasable and electromagnetically lockable doors, and wherein said at least one response means for responding to a firearm discharge comprises placing said system of electromagnetically releasable and electromagnetically lockable doors in a lockdown configuration.

12. The system and method for automatically detecting the discharge of a firearm of claim 1 wherein said at least one response means for responding to a firearm discharge comprises any combination of the group of signaling a local alarm, notifying local emergency services, or notifying a security provider.

13. The system and method for automatically detecting the discharge of a firearm of claim 1 wherein said at least one response means for responding to a firearm discharge comprises broadcasting an electronic communication to a plurality of subscribed users.

14. The system and method for automatically detecting the discharge of a firearm of claim 6 wherein said at least one response means for responding to a firearm discharge comprises any combination of the group of signaling a local alarm, notifying local emergency services, or notifying a security provider.

15. The system and method for automatically detecting the discharge of a firearm of claim 6 wherein said at least one response means for responding to a firearm discharge comprises broadcasting an electronic communication to a plurality of subscribed users.

16. The system and method for automatically detecting the discharge of a firearm of claim 7 wherein said at least one response means for responding to a firearm discharge comprises any combination of the group of signaling a local alarm, notifying local emergency services, or notifying a security provider.

17. The system and method for automatically detecting the discharge of a firearm of claim 7 wherein said at least one response means for responding to a firearm discharge comprises broadcasting an electronic communication to a plurality of subscribed users.

18. The system and method for automatically detecting the discharge of a firearm of claim 8 wherein said at least one response means for responding to a firearm discharge comprises any combination of the group of signaling a local alarm, notifying local emergency services, or notifying a security provider.

19. The system and method for automatically detecting the discharge of a firearm of claim 8 wherein said at least one response means for responding to a firearm discharge comprises broadcasting an electronic communication to a plurality of subscribed users.

20. The system and method for automatically detecting the discharge of a firearm of claim 11 wherein said at least one response means for responding to a firearm discharge comprises any combination of the group of signaling a local alarm, notifying local emergency services, or notifying a security provider.
